(19) United States
(12) Patent Application Publication
(10) Pub. No.: US 2024/0248179 A1
(43) Pub. Date: Jul. 25, 2024

(54) LIGHT SOURCE DEVICE, DISTANCE MEASURING DEVICE, AND DEVICE

(71) Applicant: SONY SEMICONDUCTOR SOLUTIONS CORPORATION, KANAGAWA (JP)

(72) Inventor: HIROYUKI HIRAIDE, KANAGAWA (JP)

(21) Appl. No.: 18/693,412

(22) PCT Filed: Aug. 19, 2022
(86) PCT No.: PCT/JP2022/031357

§ 371 Date: Mar. 19, 2024

(30) Foreign Application Priority Data
Oct. 4, 2021 (JP) 2021-163465

(51) Int. Cl. G01S 7/481; G01S 7/484; G01S 17/08

(52) U.S. Cl. CPC G01S 7/4814; G01S 7/484; G01S 17/08

(57) ABSTRACT

There is provided a light source device capable of suppressing emission of light from a light source without passing through an optical element. The light source device according to the present technology includes a light source, an optical element, and a holding unit that holds the light source and the optical element, in which the holding unit includes a package that accommodates the light source and has an opening on an optical path of light from the light source, the package being such that the optical element is attached on the package to cover the opening, and a cover that covers the optical element and the package and allows transmission of light emitted from the light source and has passed through the optical element. The light source device according to the present technology makes it possible to provide a light source device capable of suppressing the emission of the light from the light source without passing through the optical element.

### TECHNICAL FIELD

The technology according to the present disclosure (hereinafter also referred to as “present technology”) relates to a light source device, a distance measuring device, and a device.

### BACKGROUND ART

Conventionally, a light source device that emits light from a light source to the outside through an optical element has been known (e.g., see Patent Documents 1 and 2). The optical element is held by a holding member.

### CITATION LIST

### Patent Document

Patent Document 1: Japanese Patent Application Laid-Open No. 2014-85280
Patent Document 2: Japanese Patent Application Laid-Open No. 2014-190823

### SUMMARY OF THE INVENTION

### Problems to be Solved by the Invention

However, according to the conventional light source device, there has been a possibility that the light from the light source is emitted to the outside without passing through the optical element when the optical element is detached from the holding member.

In view of the above, a main object of the present technology is to provide a light source device capable of suppressing emission of light from a light source without passing through an optical element.

### Solutions to Problems

The present technology provides a light source device including:
a light source;
an optical element; and
a holding unit that holds the light source and the optical element, in which the holding unit includes:
a package that accommodates the light source and has an opening on an optical path of light from the light source, the package being such that the optical element is attached on the package to cover the opening; and
a cover that covers the optical element and the package and allows transmission of light emitted from the light source and has passed through the optical element.

The cover may suppress movement of the optical element to a position deviated from the optical path when the optical element is peeled off from the package.

The optical element may be disposed between the package and the cover.

The optical element may be sandwiched between the package and the cover.

The cover may include a resin cover member.

The cover may further include a conductive cover member that covers the resin cover member.

The holding unit may further include a substrate to which the package and the conductive cover member are attached, and a detection system that detects detachment of the conductive cover member from the substrate may be further included.

The resin cover member may have conductivity.

The holding unit may further include a substrate to which the package and the resin cover member are attached, and a detection system that detects detachment of the resin cover member from the substrate may be further included.

The cover may include a cover member that has an internal space that holds the optical element on the optical path when the optical element is peeled off from the package.

The optical element may be larger than the package.

The cover member may have conductivity.

The holding unit may further include a substrate to which the package and the cover member are attached, and a detection system that detects detachment of the cover member from the substrate may be further included.

The cover may include a conductive cover member, the holding unit may further include a substrate to which the package and the conductive cover member are attached, and a detection system that detects detachment of the conductive cover member from the substrate may be further included.

The conductive cover member may include first and second electrode portions to be coupled to the substrate, and the detection system may include a power supply unit that applies a current between the first and second electrode portions, and a voltage detection unit that detects a voltage between the first and second electrode portions.

The light source device may further include a control system that controls the light source, in which the control system may stop driving of the light source when the detection system detects the detachment.

The optical element may be a diffusion plate.

The optical element may be a diffractive optical element.

The present technology also provides a distance measuring device including the light source device, and a light receiving device that receives light emitted from the light source device and reflected by an object.

The present technology also provides a device including the distance measuring device.

### BRIEF DESCRIPTION OF DRAWINGS

FIG. 1A is a transverse sectional view of a light source device according to a first embodiment of the present technology. FIG. 1B is a longitudinal sectional view of the light source device according to the first embodiment of the present technology.

FIG. 2 is a diagram illustrating an exemplary configuration of a detection system and a control system of the light source device according to the first embodiment of the present technology.

FIG. 3 is a view illustrating a state where an optical element is peeled off from a package in the light source device according to the first embodiment of the present technology.

FIG. 4 is a view illustrating a state where the optical element is peeled off from the package and a resin cover member is detached from a substrate in the light source device according to the first embodiment of the present technology.

FIG. 5 is a view illustrating a state where a conductive cover member is detached from the substrate in the light source device according to the first embodiment of the present technology.

FIG. 6 is a flowchart for explaining an operation of the light source device according to the first embodiment of the present technology.

FIG. 7A is a longitudinal sectional view of a light source device according to a first comparative example.

FIG. 7B is a view illustrating a state where an optical element is peeled off from a package in the light source device according to the first comparative example.

FIG. 8 is a longitudinal sectional view of a light source device according to a second comparative example.

FIG. 9A is a longitudinal sectional view of a light source device according to a third comparative example.

FIG. 9B is a view illustrating a state where an optical element is peeled off from a package in the light source device according to the third comparative example.

FIG. 10A is a transverse sectional view of a light source device according to a second embodiment of the present technology. FIG. 10B is a longitudinal sectional view of the light source device according to the second embodiment of the present technology.

FIG. 11 is a view illustrating a state where an optical element is peeled off from a package in the light source device according to the second embodiment of the present technology.

FIG. 12A is a transverse sectional view of a light source device according to a third embodiment of the present technology. FIG. 12B is a longitudinal sectional view of the light source device according to the third embodiment of the present technology.

FIG. 13 is a view illustrating a state where an optical element is peeled off from a package in the light source device according to the third embodiment of the present technology.

FIG. 14A is a longitudinal sectional view of a light source device according to a fourth comparative example. FIG. 14B is a view illustrating a state where an optical element is peeled off from a package in the light source device according to the fourth comparative example.

FIG. 15 is a longitudinal sectional view of a light source device according to a first variation of the first embodiment.

FIG. 16 is a longitudinal sectional view of a light source device according to a second variation of the first embodiment.

FIG. 17 is a longitudinal sectional view of a light source device according to a third variation of the first embodiment.

FIG. 18A is a longitudinal sectional view of a light source device according to a variation of the third embodiment. FIG. 18B is a view illustrating a state where an optical element is peeled off from a package in the light source device according to the variation of the third embodiment.

FIG. 19 is a diagram illustrating exemplary application of the light source device according to the first embodiment of the present technology to a distance measurement device.

FIG. 20 is a block diagram depicting an exemplary schematic configuration of a vehicle control system.

FIG. 21 is an explanatory diagram illustrating exemplary installation positions of the distance measurement device.

### MODE FOR CARRYING OUT THE INVENTION

Hereinafter, preferred embodiments of the present technology will be described in detail with reference to the accompanying drawings. Note that, in the present specification and the drawings, components having substantially the same functional configurations are denoted by the same reference signs, and redundant descriptions are omitted. The embodiments to be described below provide representative embodiments of the present technology, and the scope of the present technology is not to be narrowly interpreted according to those embodiments. In the present specification, even in a case where each of a light source device, a distance measuring device, and a device according to the present technology is described to exert a plurality of effects, each of the light source device, the distance measuring device, and the device according to the present technology is only required to exert at least one effect. The effects described in the present specification are merely examples and are not limited, and other effects may be exerted.

Furthermore, the description will be given in the following order.
1. Introduction
2. Light Source Device According to First
Embodiment of Present Technology
3. Light Source Device According to Second
Embodiment of Present Technology
4. Light Source Device According to Third
Embodiment of Present Technology
5. Variations of Present Technology
6. Exemplary Application to Electronic Device
7. Exemplary Application of Light Source Device to Distance Measurement Device
8. Exemplary Installation of Distance Measurement

### Device to Mobile Body

### <1. Introduction>

A time of flight (TOF) sensor (distance measuring device) generally uses a laser as a light source. In such a TOF sensor, laser light from the laser is emitted through an optical element such as a diffusion plate, whereby it becomes possible to diffuse or diffract the laser light and uniformly emit the laser light within a distance measurement range.

However, when the optical element is detached from a holding member due to some failure, there is a possibility that the laser light from the laser is emitted without passing through the optical element while maintaining high intensity.

In view of the above, the inventor has developed the light source device according to the present technology to cope with this problem after intensive studies.

### <2. Light Source Device According to First Embodiment of Present Technology>

Hereinafter, a light source device 10 according to a first embodiment of the present technology will be described with reference to the drawings.

### <<Configuration of Light Source Device>>

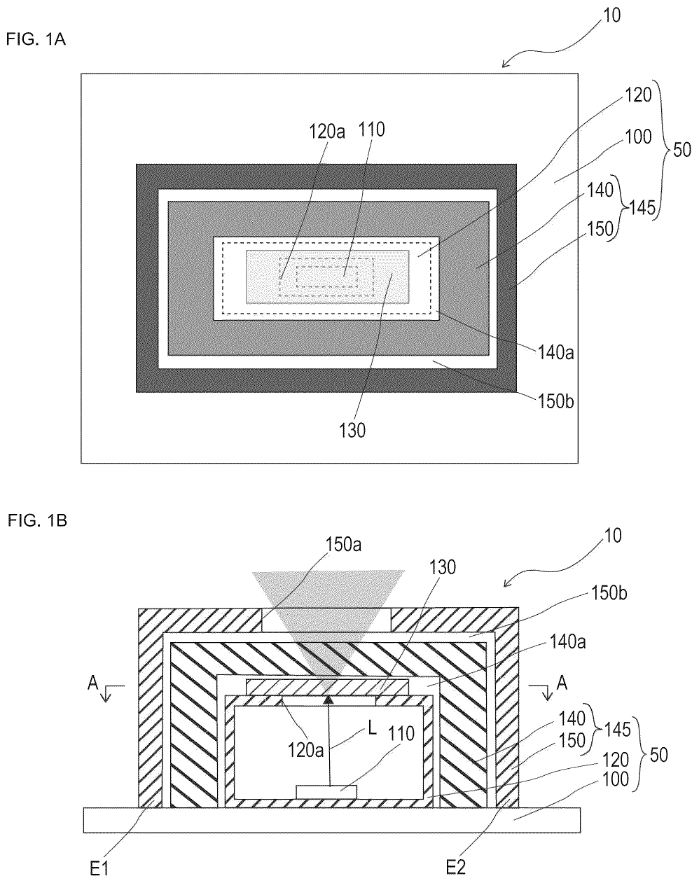

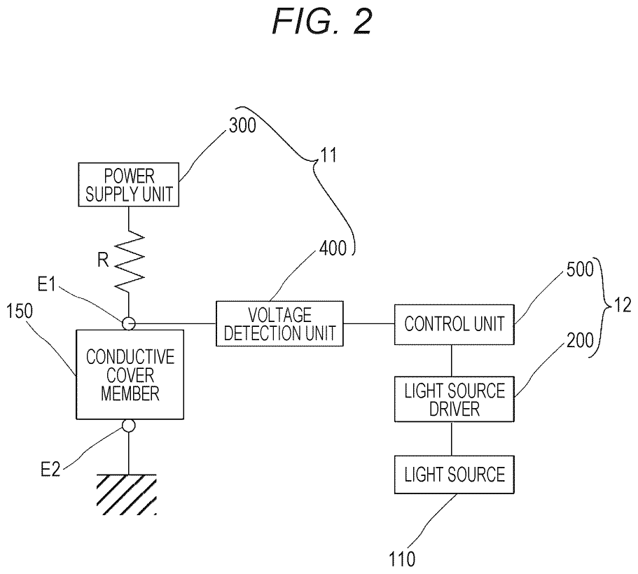

FIG. 1A is a transverse sectional view of the light source device 10 according to the first embodiment of the present technology. FIG. 1B is a longitudinal sectional view of the light source device 10 according to the first embodiment of the present technology. FIG. 1A is a cross-sectional view taken along line A-A in FIG. 1B. Hereinafter, the upper side in the longitudinal section of FIG. 1B and the like will be described as an upper part, and the lower side will be described as a lower part for the sake of convenience. FIG. 2 is a diagram illustrating an exemplary configuration of a detection system and a control system of the light source device according to the first embodiment of the present technology.

The light source device 10 is used as a light source unit of a TOF sensor, for example. The TOF sensor is mounted on an electronic device such as a smartphone, a digital camera, or the like, a mobile body such as a vehicle, an aircraft (including drone), a ship, or the like, an industrial machine, or the like.

As illustrated in FIGS. 1A and 1B, the light source device 10 includes a light source 110, an optical element 130, and a holding unit 50 that holds the light source 110 and the optical element 130. As illustrated in FIG. 2, the light source device 10 further includes a detection system 11 and a control system 12.

The holding unit 50 includes a package 120 that houses the light source 110, and a cover 145 that covers the optical element 130 and the package 120. The holding unit 50 further includes a substrate 100 to which the package 120 and the cover 145 are attached.

### (Substrate)

The substrate 100 is, for example, a circuit board (e.g., printed wiring substrate).

### (Package)

The package 120 is mounted on the substrate 100, for example. The package 120 has an opening 120a on an optical path of light L from the light source 110, for example. Specifically, for example, the package 120 includes a box-shaped member, the light source 110 is mounted on an inner surface of a bottom wall portion (lower wall portion), and an upper wall portion has the opening 120a facing the light source 110. The package 120 includes, for example, a material such as metal, ceramic, resin, or the like.

### (Light Source)

The light source 110 is, for example, a laser such as a laser diode (LD) (edge emitting laser), a vertical cavity surface emitting laser (VCSEL) (surface emitting laser), or the like. Note that the light source 110 may be, for example, a light-emitting diode (LED), an organic light-emitting diode (OLED), or the like. The light source 110 is, for example, an invisible light source, and emits infrared light (IR light), for example. The light source 110 is controlled by the control system 12 (see FIG. 2).

### (Optical Element)

The optical element 130 is attached to the package 120 to cover the opening 120a. That is, the optical element 130 is attached to the package 120 to be positioned on the optical path of the light L from the light source 110. Specifically, for example, the optical element 130 is joined (e.g., bonded) to the outer surface of the upper wall portion of the package 120 to cover the opening 120a. For example, the optical element 130 is smaller than the package 120 at least in plan view (see FIGS. 1A and 1B).

The optical element 130 may be any element as long as it diffuses or diffracts incident light while transmitting the incident light, such as a transmissive diffusion plate, a transmissive diffractive optical element (including diffractive optical element (DOE), holographic optical element (HOE), etc.), a diffusing lens, or the like. The optical element 130 includes, for example, a material (e.g., resin, glass, etc.) that transmits IR light.

For example, the optical element 130 is disposed between the package 120 and the cover 145. Specifically, the optical element 130 is disposed between the package 120 and a resin cover member 140. More specifically, the optical element 130 is disposed between the upper wall of the package 120 and the upper wall of the resin cover member 140.

The optical element 130 is preferably sandwiched between the package 120 and the cover 145. That is, it is preferable that thickness of the optical element 130 substantially matches the distance between the upper wall of the package 120 and the upper wall of the resin cover member 140.

### (Cover)

The cover 145 allows light emitted from the light source 110 and has passed through the optical element 130 to pass.

The cover 145 includes the resin cover member 140 and a conductive cover member 150 that covers the resin cover member 140 and is separate from the resin cover member 140.

For example, the resin cover member 140 includes a box-shaped member having a substantially U-shaped longitudinal section, and an opening end portion if joined (e.g., bonded) to the substrate 100 to cover the optical element 130 and the package 120. The resin cover member 140 includes, for example, resin through which light (e.g., IR light) from the light source 110 passes.

For example, the conductive cover member 150 includes a box-shaped member having a substantially U-shaped longitudinal section, which is larger than the resin cover member 140, and an opening end portion is coupled to the substrate 100 to cover the resin cover member 140. The conductive cover member 150 includes, for example, a window portion 150a through which light emitted from the light source 110 and has passed through the optical element 130 and the resin cover member 140 passes. The conductive cover member 150 includes a conductive material, such as meal, alloy, conductive resin, or the like. The conductive cover member 150 includes a first and second electrode portions E1 and E2 to be coupled to the substrate 100. The first and second electrode portions E1 and E2 are, for example, two facing portions of the opening end portion of the conductive cover member 150.

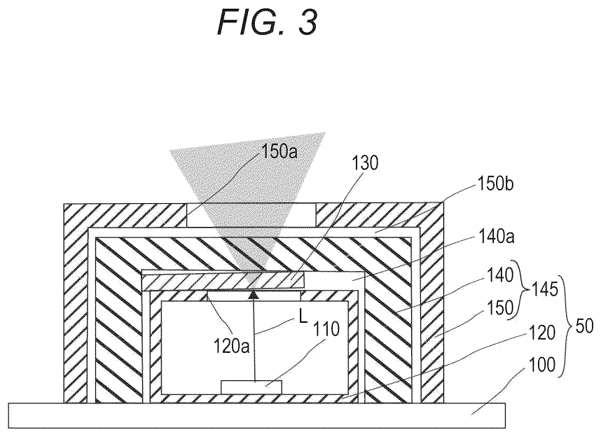

FIG. 3 is a view illustrating a state where the optical element 130 is peeled off from the package 120 in the light source device 10. As illustrated in FIG. 3, when the optical element 130 is peeled off from the package 120, the cover 145 suppresses movement of the optical element 130 to a position deviated from the optical path of the light L from the light source 110. Specifically, the resin cover member 140 has an internal space 140a that holds the optical element 130 on the optical path when the optical element 130 is peeled off from the package 120. The internal space 140a restricts the movement of the optical element 130 such that the optical element 130 peeled off from the package 120 continues to be positioned on the optical path of the light L from the light source 110.

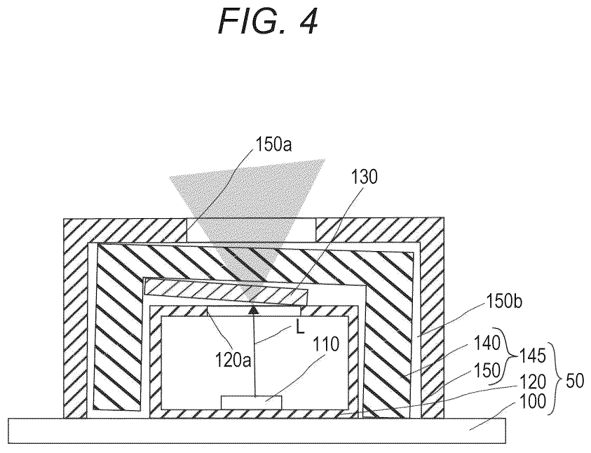

FIG. 4 is a view illustrating a state where the optical element 130 is peeled off from the package 120 and the resin cover member 140 is detached from the substrate 100 in the light source device 10. As illustrated in FIG. 4, when the optical element 130 is peeled off from the package 120 and the resin cover member 140 is detached from the substrate 100, the cover 145 suppresses the movement of the optical element 130 to a position deviated from the optical path of the light L from the light source 110. Specifically, the conductive cover member 150 of the cover 145 has an internal space 150b that holds the optical element 130 on the optical path when the optical element 130 is peeled off from the package 120 and the resin cover member 140 is detached from the substrate 100. The internal space 150b restricts the movement of the resin cover member 140 such that the optical element 130 peeled off from the package 120 continues to be positioned on the optical path of the light L from the light source 110 in the resin cover member 140 detached from the substrate 100.

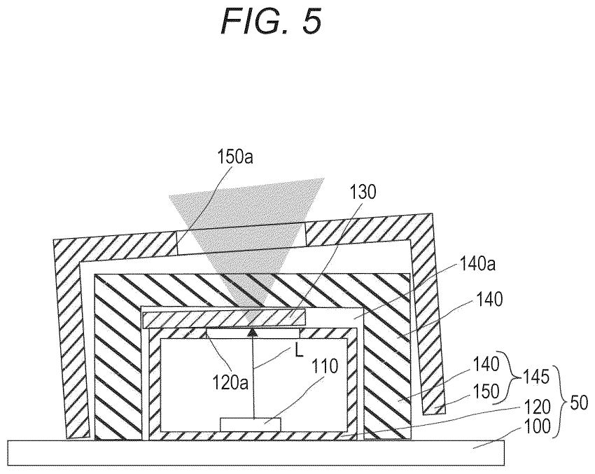

FIG. 5 is a view illustrating a state where the optical element 130 is peeled off from the package 120 and the conductive cover member 150 is detached from the substrate 100 in the light source device 10. Even if the optical element 130 is peeled off from the package 120 and the conductive cover member 150 is detached from the substrate 100 as illustrated in FIG. 5, the resin cover member 140 may suppress deviation of the optical element 130 from the optical path of the light L from the light source 110 as long as the resin cover member 140 is in a state of being attached to the substrate 100.

As described above, the cover 145 has the double structure in the light source device 10, whereby, even if one of the cover members is detached from the substrate 100, the movement of the optical element 130 peeled off from the package 120 may be restricted as long as the other one of the cover members is attached to the substrate 100.

However, when the resin cover member 140 is further detached from the substrate 100 from the state illustrated in FIG. 5, the optical element 130 deviates from the optical path of the light L from the light source 110, and the light L (e.g., laser light) is emitted to the outside without being diffused.

In view of the above, the light source device 10 detects detachment of the conductive cover member 150 from the substrate 100 using the detection system 11.

### (Detection System)

The detection system 11 is provided on the substrate 100, for example. As illustrated in FIG. 2, the detection system 11 includes a power supply unit 300 that applies a current between the first and second electrode portions E1 and E2 of the conductive cover member 150, and a voltage detection unit 400 that detects a voltage between the first and second electrode portions E1 and E2. The detection system 11 further includes, for example, a resistor R coupled between the power supply unit 300 and the first electrode portion E1.

The second electrode portion E2 is coupled (grounded) to a ground terminal provided on the substrate 100, for example. The voltage detection unit 400 is, for example, a voltmeter that detects a voltage (e.g., potential of the first electrode portion E1) between the first and second electrode portions E1 and E2. The voltage detection unit 400 outputs the detected voltage to the control system 12.

### (Control System)

The control system 12 is provided on the substrate 100, for example. The control system 12 causes driving of the light source 110 to stop when the detection system 11 detects detachment of the conductive cover member 150. The control system 12 includes, for example, a light source driver 200 that drives the light source 110, and a control unit 500 that controls the light source driver 200 on the basis of a detection result (e.g., potential of the first electrode portion E1) in the detection system 11. The control unit 500 is implemented by hardware including, for example, a central processing unit (CPU), a chip set, and the like.

### <<Operation of Light Source Device>>

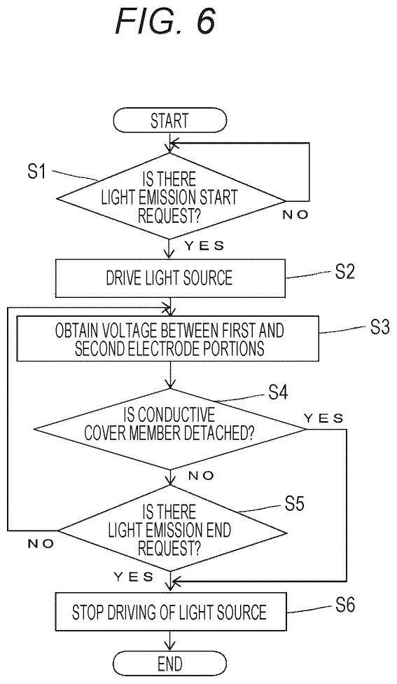

Hereinafter, operation of the light source device 10 will be described with reference to a flowchart of FIG. 6.

In the first step S1, the control unit 500 determines whether or not a light emission start request has been issued. Specifically, for example, the control unit 500 determines that the light emission start request has been issued when a signal making notification of the fact that a standby mode has been switched to a distance measuring mode is received from a central processing unit (CPU) of the TOF sensor on which the light source device 10 is mounted. The process proceeds to step S2 if the determination in step S1 is positive, and the same determination is performed if the determination is negative (i.e., it enters a standby state).

In the next step S2, the control unit 500 drives the light source 110. Specifically, for example, the control unit 500 applies a light emission signal (pulse signal) to the light source 110 to cause the light source 110 to perform pulse light emission.

In the next step S3, the control unit 500 obtains the voltage between the first and second electrode portions E1 and E2. Specifically, the control unit 500 obtains the potential of the first electrode portion E1 from the voltage detection unit 400.

In the next step S4, the control unit 500 determines whether or not the conductive cover member 150 has been detached. Specifically, the control unit 500 determines that the conductive cover member 150 has been detached when the voltage between the first and second electrode portions E1 and E2 obtained in step S3 is at a high level, and determines that the conductive cover member 150 has not been detached when the voltage is at a low level. As a supplement, when the voltage between the first and second electrode portions E1 and E2 is at a low level, a current flows between the first and second electrode portions E1 and E2 in the conductive cover member 150, and the voltage between the first and second electrode portions E1 and E2 is approximately 0 V. In this case, it may be estimated that both the first and second electrode portions E1 and E2 are coupled to the substrate 100. On the other hand, when the voltage between the first and second electrode portions E1 and E2 is at a high level, no current flows between the first and second electrode portions E1 and E2 in the conductive cover member 150, and the voltage between the first and second electrode portions E1 and E2 becomes equal to the voltage (power supply voltage) of the power supply unit 300. In this case, it may be estimated that at least one of the first electrode portion E1 or the second electrode portion E2 is detached from the substrate 100, that is, the conductive cover member 150 is detached. The process proceeds to step S6 if the determination in step S4 is positive, and proceeds to step S5 if the determination is negative.

In step S5, the control unit 500 determines whether or not a light emission end request has been issued. Specifically, the control unit 500 determines that the light emission end request has been issued when a signal making notification of the fact that the distance measuring mode has been switched to the standby mode is received from the CPU of the TOF sensor on which the light source device 10 is mounted. The process proceeds to step S6 if the determination in step S5 is positive, and returns to step S3 if the determination is negative.

In step S6, the control unit 500 causes driving of the light source 110 to stop. Specifically, the control unit 500 stops application of the light emission signal to the light source 110. When step S6 is executed, the flow is terminated.

### <<Effects of Light Source Device>>

The light source device 10 according to the first embodiment of the present technology includes the light source 110, the optical element 130, and the holding unit 50 that holds the light source 110 and the optical element 130, in which the holding unit 50 includes the package 120 that accommodates the light source 110 and has the opening 120a on the optical path of the light from the light source 110, the package 120 being such that the optical element 130 is attached thereon to cover the opening 120a, and the cover 145 that covers the optical element 130 and the package 120 and allows transmission of light emitted from the light source 110 and has passed through the optical element 130.

In this case, even if the optical element 130 is peeled off from the package 120, the cover 145 may suppress movement of the optical element 130 to a position deviated from the optical path of the light L from the light source 110 (e.g., see FIG. 3).

As a result, according to the light source device 10 of the first embodiment, it becomes possible to provide a light source device capable of suppressing emission of light from the light source 110 without passing through the optical element 130.

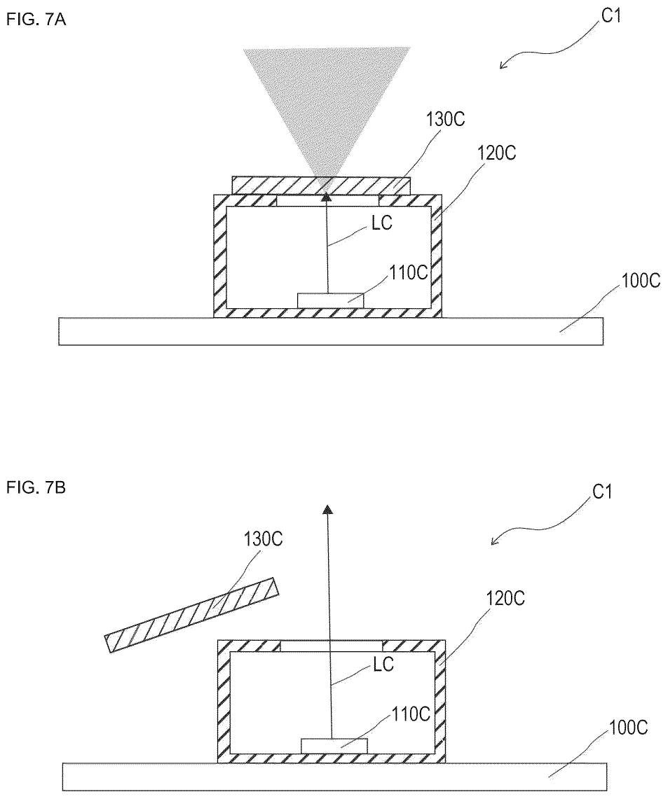

Here, a light source device C1 according to a first comparative example illustrated in FIG. 7A includes a substrate 100C, a light source 110C, a package 120C, and an optical element 130C. That is, the light source device C1 has a configuration similar to that of the light source device 10 according to the first embodiment except that a cover is not included. As illustrated in FIG. 7B, when the optical element 130C is peeled off from the package 120C in the light source device C1, light LC (e.g., laser light) from the light source 110C is directly emitted without being diffused or diffracted. Therefore, not only the function of the light source device 10 (function of irradiating a desired distance measurement range with light) is impaired, but also an unfavorable situation in terms of safety may occur. A situation similar to that of the light source device C1 according to the first comparative example may occur also in the light source devices disclosed in Patent Documents 1 and 2.

It is preferable that the cover 145 suppresses movement of the optical element 130 to a position deviated from the optical path of the light L from the light source 110 when the optical element 130 is peeled off from the package 120. With this arrangement, it becomes possible to suppress emission of the light L from the light source 110 without passing through the optical element 130.

The optical element 130 is preferably disposed between the package 120 and the cover 145. With this arrangement, the internal space of the cover 145 (specifically, resin cover member 140) may restrict the movement of the optical element 130 peeled off from the package 120.

The optical element 130 may be sandwiched between the package 120 and the cover 145. With this arrangement, the movement of the optical element 130 peeled off from the package 120 may be further restricted.

The cover 145 may include the resin cover member 140. With this arrangement, it becomes possible to reduce weight of the light source device 10.

The cover 145 may further include the conductive cover member 150 that covers the resin cover member 140. With this arrangement, it becomes possible to electrically detect detachment of the conductive cover member 150.

The holding unit 50 may further include the substrate 100 to which the package 120 and the conductive cover member 150 are attached, and the light source device 10 may further include the detection system 11 that detects detachment of the conductive cover member 150 from the substrate 100. With this arrangement, even if the conductive cover member 150 is detached from the substrate 100, safety may be secured by performing processing to cope with the detachment.

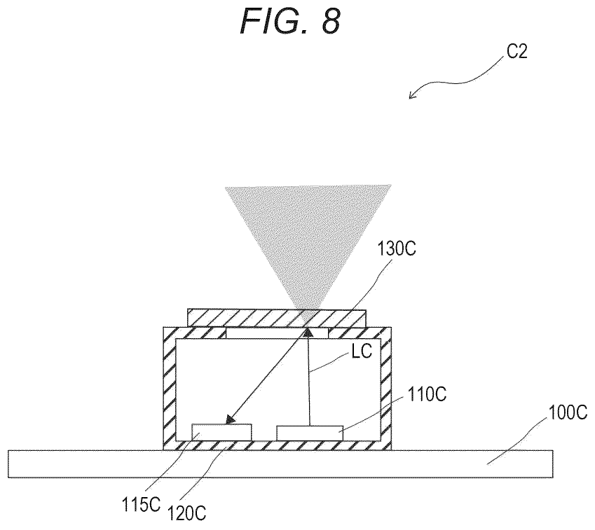

On the other hand, a light source device C2 according to a second comparative example illustrated in FIG. 8 includes the substrate 100C, the light source 110C, a light receiving element 115C (e.g., photodiode), the package 120C, and the optical element 130C. The light source 110C and the light receiving element 115C are mounted on an inner surface of a bottom wall of the package 120C.

In the light source device C2, a part of the light LC emitted from the light source 110C is diffused or diffracted while being transmitted through the optical element 130C, and another part is reflected by the optical element 130C and incident on the light receiving element 115C. In this case, whether or not the optical element 130C is detached from the package 120C may be detected by the output of the light receiving element 115C. However, according to the light source device C2, there is a possibility that the presence or absence of detachment of the optical element 130C is erroneously detected in a case where, for example, the output of the light receiving element 115C largely fluctuates due to a rapid temperature change or the like.

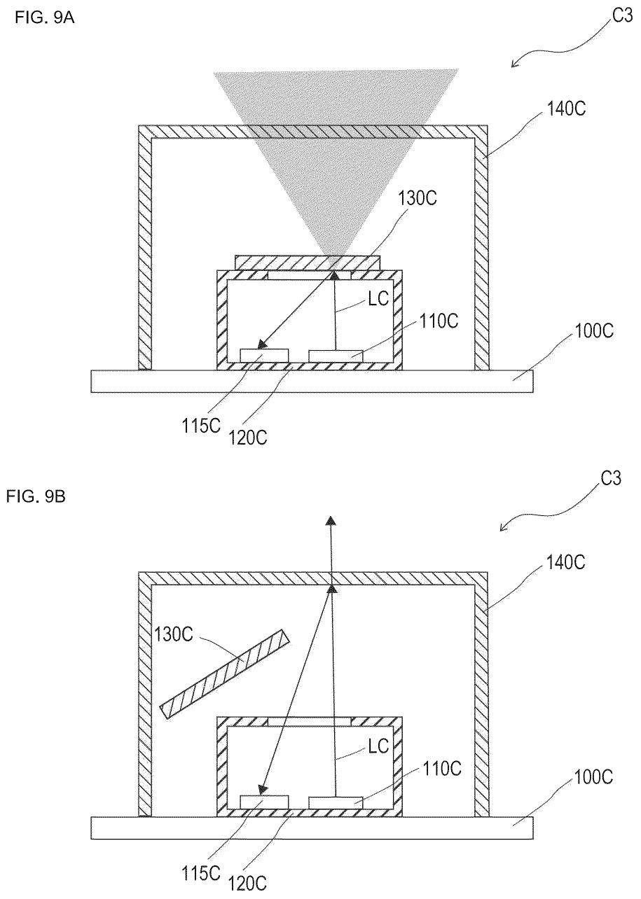

Furthermore, a light source device C3 according to a third comparative example illustrated in FIG. 9A includes, in addition to the configuration of the light source device C2 according to the second comparative example, a cover member 140C, which covers the package 120C and the optical element 130C and has high transparency for the purpose of presentation. As illustrated in FIG. 9B, according to the light source device C3, while a part of the light LC emitted from the light source 110C is directly transmitted through the cover member 140C and emitted to the outside, another part is reflected by the cover member 140C and incident on the light receiving element 115C when the optical element 130C is peeled off from the package 120C, whereby there is a possibility that peeling off of the optical element 130C from the package 120C fails to be detected and an unfavorable situation in terms of safety may occur.

Furthermore, according to the light source device disclosed in Patent Document 1, it is necessary to provide an electrode and wiring in a diffractive optical element itself to detect detachment of the diffractive optical element, and moreover, a wiring path for connecting the wiring and a circuit on a substrate becomes complex, which leads to an increase in cost.

Furthermore, according to the light source device disclosed in Patent Document 2, it is necessary to provide an electrode and wiring in a package to detect detachment of a diffractive optical element, and moreover, a wiring path for connecting the wiring and a circuit on a substrate becomes complex, which leads to an increase in cost.

The cover 145 preferably includes the resin cover member 140 having the internal space 140a that keeps the optical element 130 on the optical path of the light L from the light source 110 when the optical element 130 is peeled off from the package 120. With this arrangement, it becomes possible to reliably suppress emission of light from the light source 110 without passing through the optical element 130.

The conductive cover member 150 may include the first and second electrode portions E1 and E2 to be coupled to the substrate 100, and the detection system 11 may include the power supply unit 300 that applies a current between the first and second electrode portions E1 and E2, and the voltage detection unit 400 that detects a voltage between the first and second electrode portions E1 and E2. With this arrangement, it becomes possible to detect detachment of the conductive cover member 150 from the substrate 100 with a simple configuration without increasing the cost.

It is preferable that the light source device 10 further includes the control system 12 that controls the light source 110 and the control system 12 causes driving of the light source 110 to stop when the detection system 11 detects detachment of the conductive cover member 150. With this arrangement, the safety may be secured.

The optical element 130 may be a diffusion plate. With this arrangement, the light L from the light source 110 may be diffused to uniformly irradiate the desired distance measurement range with light.

The optical element 130 may be a diffractive optical element. With this arrangement, the light L from the light source 110 may be diffracted at a desired diffraction angle to uniformly irradiate the desired distance measurement range with light.

### <3. Light Source Device According to Second Embodiment of Present Technology>

Hereinafter, a light source device 20 according to a second embodiment of the present technology will be described with reference to the drawings.

### <<Configuration of Light Source Device>>

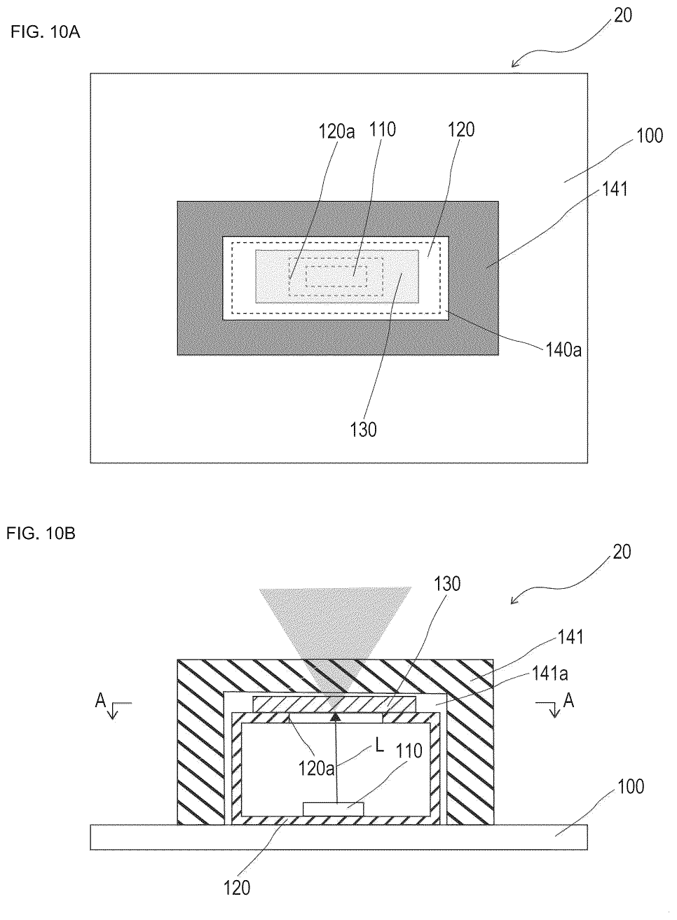

FIG. 10A is a transverse sectional view of the light source device 20 according to the second embodiment of the present technology. FIG. 10B is a longitudinal sectional view of the light source device 20 according to the second embodiment of the present technology. FIG. 10A is a cross-sectional view taken along line A-A in FIG. 10B.

The light source device 20 according to the second embodiment has a configuration roughly similar to that of the light source device 10 according to the first embodiment except that a cover includes only a conductive resin cover member 141 (conductive cover member).

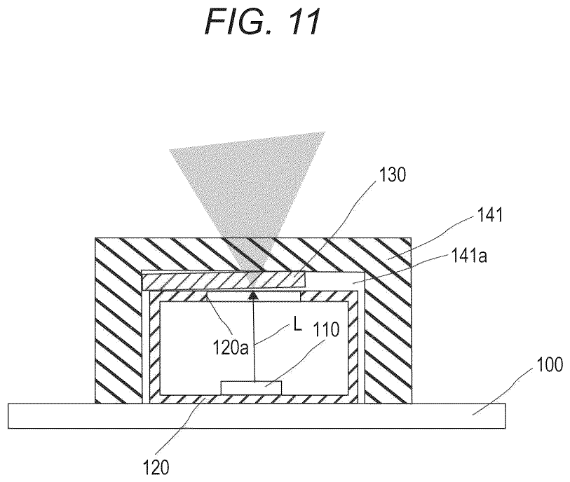

The resin cover member 141 has an internal space similar to that of the resin cover member 140 described above. That is, as illustrated in FIG. 11, the resin cover member 141 has an internal space 141a that holds an optical element 130 on an optical path of light L from a light source 110 when the optical element 130 is peeled off from a package 120.

The resin cover member 141 is coupled to a substrate 100 in a similar manner to the conductive cover member 150 described above. The light source device 20 includes a detection system that detects detachment of the resin cover member 141 from the substrate 100. The detection system has, for example, a configuration and a function similar to those of the detection system 11 described above.

According to the light source device 20 of the second embodiment, while effects exerted by a cover having a double structure may not be obtained, the resin cover member 141 also has the function of the conductive cover member 150 described above as compared with the light source device 10 according to the first embodiment, whereby it becomes possible to detect detachment of the resin cover member 141 from the substrate 100 while reducing the number of components and reducing the size.

### <4. Light Source Device According to Third Embodiment of Present Technology>

Hereinafter, a light source device 30 according to a third embodiment of the present technology will be described with reference to the drawings.

### <<Configuration of Light Source Device>>

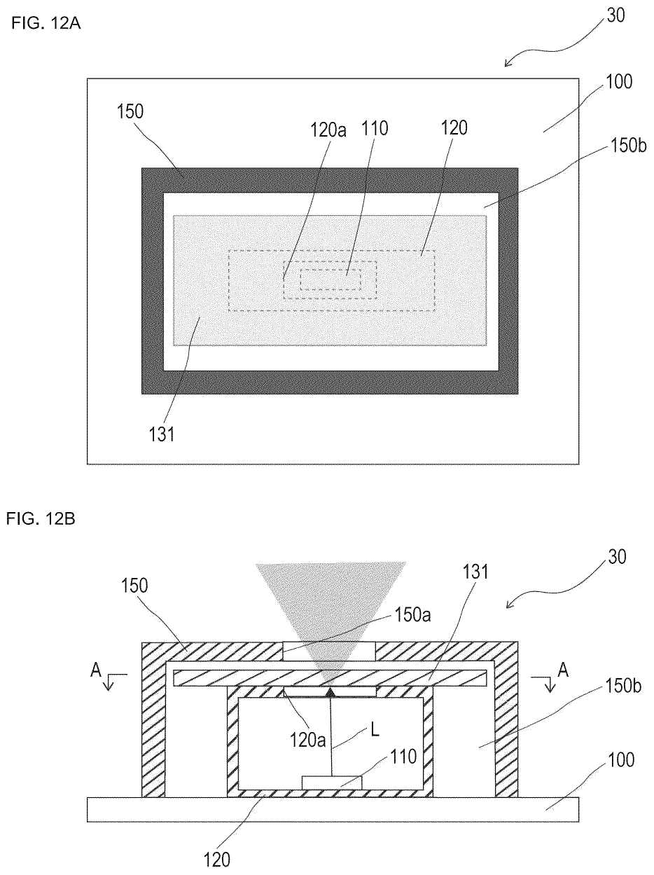

FIG. 12A is a transverse sectional view of the light source device 30 according to the third embodiment of the present technology. FIG. 12B is a longitudinal sectional view of the light source device 30 according to the third embodiment of the present technology. FIG. 12A is a cross-sectional view taken along line A-A in FIG. 12B.

The light source device 30 according to the third embodiment has a configuration roughly similar to that of the light source device 10 according to the first embodiment except that a cover includes only a conductive cover member 150 and an optical element 131 is larger than a package 120.

As illustrated in FIGS. 12A and 12B, the optical element 131 is larger than the package 120 at least in plan view.

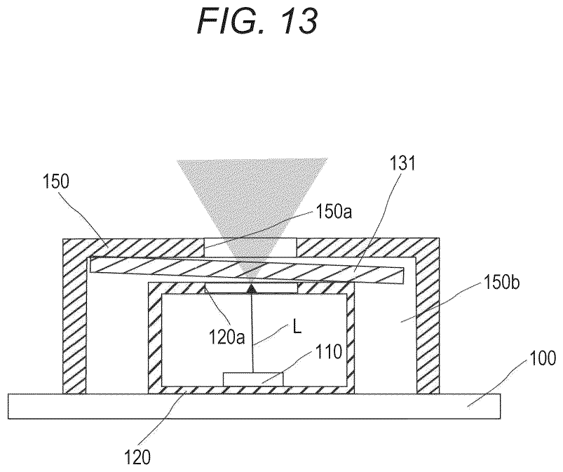

As illustrated in FIG. 13, in the light source device 30, the conductive cover member 150 has an internal space 150b that holds the optical element 131 on an optical path of light L from a light source 110 when the optical element 131 is peeled off from the package 120.

Also in the light source device 30, a detection system 11 detects detachment of the conductive cover member 150 from the substrate 100, and a control system 12 controls the light source 110.

According to the light source device 30 of the third embodiment, while effects exerted by a cover having a double structure may not be obtained, the conductive cover member 150 also has a function similar to that of the resin cover member 140 described above (movement limiting function of the optical element 131) as compared with the light source device 10 according to the first embodiment, whereby it becomes possible to detect detachment of the conductive cover member 150 from the substrate 100 while reducing the number of components and reducing the size.

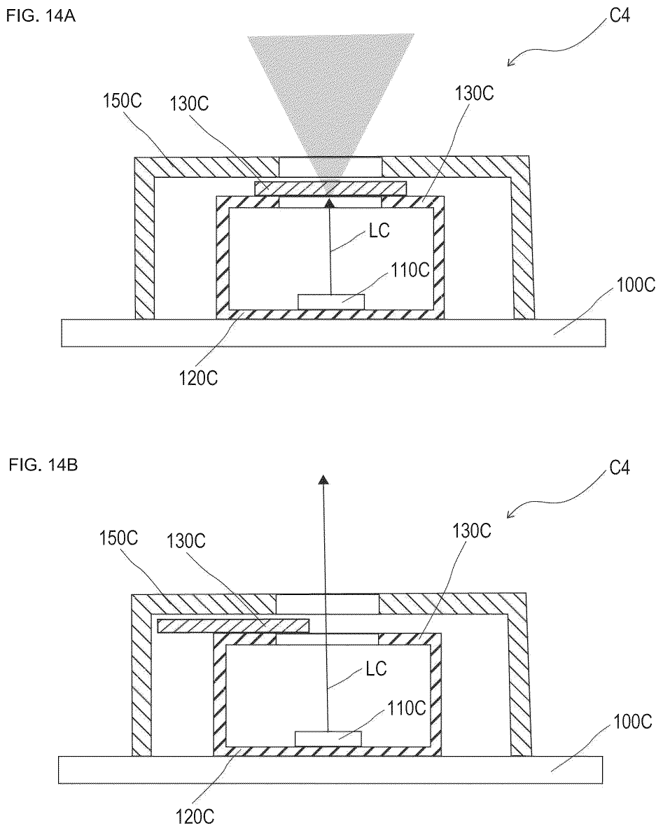

Here, a light source device C4 according to a fourth comparative example illustrated in FIG. 14A has a configuration similar to that of the light source device C1 according to the first comparative example except that a conductive cover member 150C is included. According to the light source device C4 of the fourth comparative example, since the conductive cover member 150C does not have a movement limiting function of the optical element 130C peeled off from the package 120C, movement of the optical element 130C peeled off from the package 120C to a position deviated from the optical path of the light LC from the light source 110C may not be suppressed as illustrated in FIG. 14B. Accordingly, there is a possibility that the light L (e.g., laser light) from the light source 110C is directly emitted to the outside, which is an unfavorable situation in terms of safety.

### <5. Variations of Present Technology>

The light source devices according to the respective embodiments described above may be changed as appropriate.

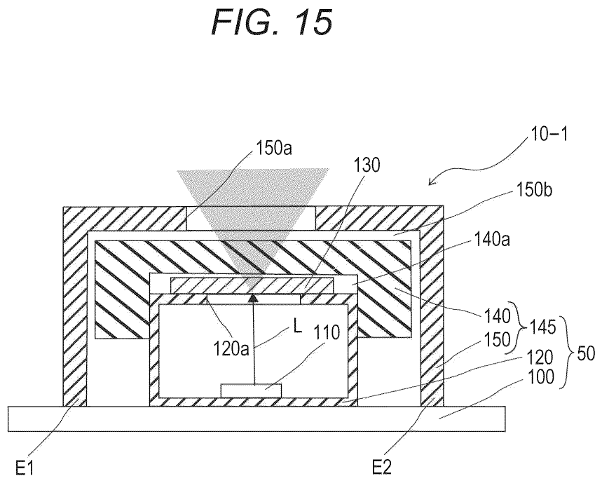

For example, as in a light source device 10-1 according to a first variation of the first embodiment illustrated in FIG. 15, the resin cover member 140 may not be attached to the substrate 100, and may be joined to the outer surface of the package 120 to cover the optical element 130.

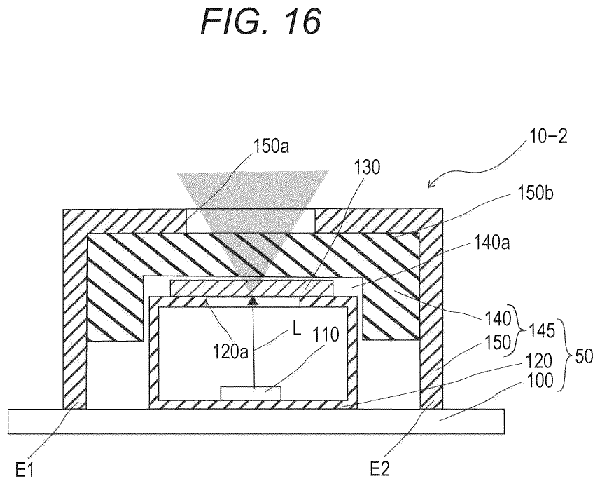

For example, as in a light source device 10-2 according to a second variation of the first embodiment illustrated in FIG. 16, the resin cover member 140 may not be attached to the substrate 100, and may be joined to the inner surface of the conductive cover member 150 to cover the optical element 130.

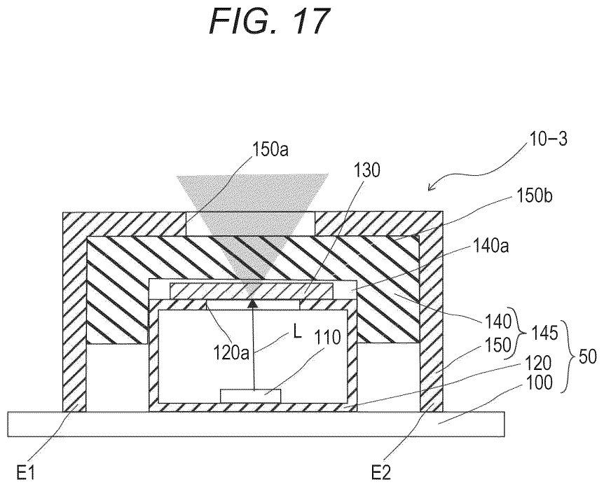

For example, as in a light source device 10-3 according to a third variation of the first embodiment illustrated in FIG. 17, the resin cover member 140 may not be attached to the substrate 100, and may be joined to both the outer surface of the package 120 and the inner surface of the conductive cover member 150 to cover the optical element 130.

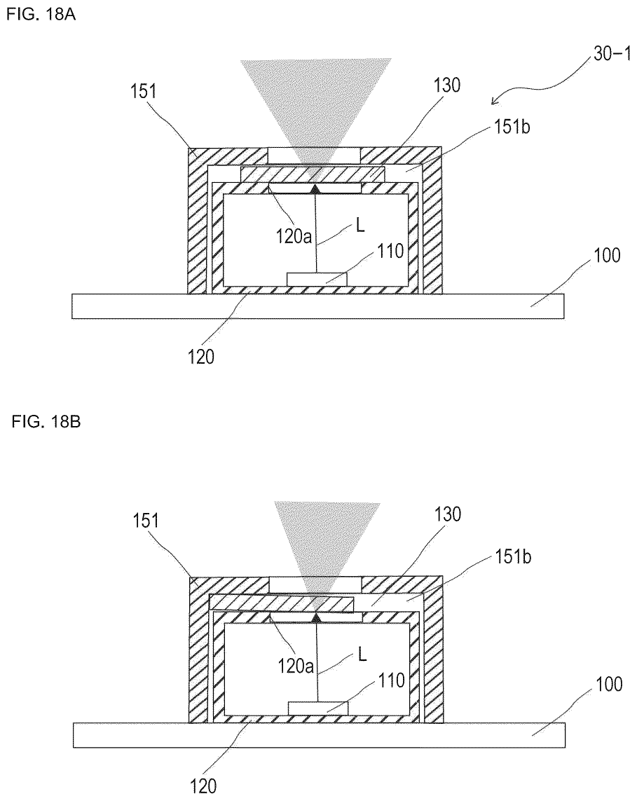

For example, as in a light source device 30-1 according to a variation of the third embodiment illustrated in FIG. 18A, a cover may include only a conductive cover member 151, and the conductive cover member 151 may have an internal space 151b that holds the optical element 130 peeled off from the package 120 on the optical path of the light L from the light source 110 (see FIG. 18B).

For example, in each of the light source devices according to the respective embodiments and the respective variations described above, the cover may not include the conductive cover member (including conductive resin cover member). In this case, the light source device may not include the detection system and the control unit.

For example, while each of the light source devices according to the respective embodiments and the respective variations described above is configured such that the light emitted from the light source 110 is directly made incident on the optical element 130, a configuration may be adopted in which the light emitted from the light source 110 is made incident on the optical element 130 via an optical system including, for example, a lens, a mirror, and the like.

For example, in each of the light source devices according to the respective embodiments and the respective variations described above, the detection system and the control system may be mounted on a substrate different from the substrate 100.

For example, some of the light source devices according to the respective embodiments and the respective variations described above may be combined within a range not inconsistent with each other.

For example, in each of the respective embodiments and the respective variations described above, the material, shape, size, arrangement, and the like of each component included in the light source device may be changed as appropriate.

### <6. Exemplary Application to Electronic Device>

The light source device and the distance measuring device including the light source device according to the present technology is applicable to various products (devices). For example, the light source device and the distance measuring device according to the present technology may be implemented as an apparatus (device) to be mounted on any type of mobile bodies such as an automobile, an electric automobile, a hybrid electric automobile, a motorcycle, a bicycle, a personal mobility, an airplane, a drone, a ship, a robot, and the like. For example, the light source device and the distance measuring device according to the present technology may be implemented as an apparatus (device) to be mounted on an object recognition device that recognizes a three-dimensional shape of an object.

### <7. Exemplary Application of Light Source Device to Distance Measurement Device>

Hereinafter, exemplary application of the light source devices according to the respective embodiments described above will be described.

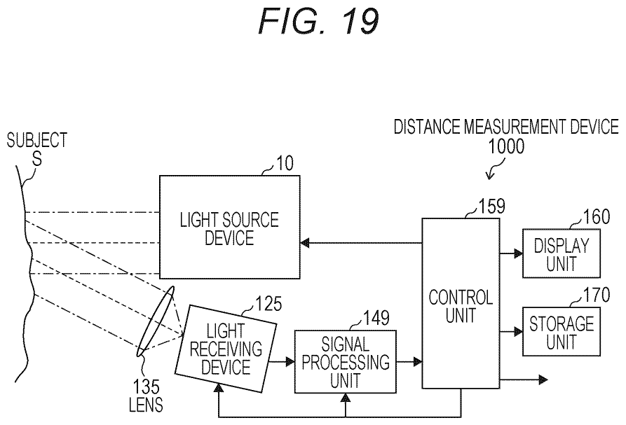

FIG. 19 illustrates an exemplary schematic configuration of a distance measurement device 1000 (distance measuring device) including the light source device 10 as an exemplary electronic device according to the present technology. The distance measurement device 1000 is a device (TOF sensor) that measures a distance to a subject S by a time of flight (TOF) method. The distance measurement device 1000 includes the light source device 10 as a light source unit. The distance measurement device 1000 includes, for example, the light source device 10, a light receiving device 125, a lens 135, a signal processing unit 149, a control unit 159, a display unit 160, and a storage unit 170.

The light receiving device 125 detects light emitted from the light source device 10 and reflected by the subject S. The lens 135 is a lens for condensing the light reflected by the subject S and guiding the light to the light receiving device 125, and is a condenser lens.

The signal processing unit 149 is a circuit for generating a signal corresponding to a difference between a signal input from the light receiving device 125 and a reference signal input from the control unit 159. The control unit 159 includes, for example, a time-to-digital converter (TDC). The reference signal may be a signal input from the control unit 159, or may be an output signal of a detection unit that directly detects the output of the light source device 10. The control unit 159 is, for example, a processor that controls the light source device 10, the light receiving device 125, the signal processing unit 149, the display unit 160, and the storage unit 170. The control unit 159 is a circuit that measures a distance to the subject S on the basis of the signal generated by the signal processing unit 149. The control unit 159 generates a video signal for displaying information regarding the distance to the subject S, and outputs it to the display unit 160. The display unit 160 displays the information regarding the distance to the subject S on the basis of the video signal input from the control unit 159. The control unit 159 stores the information regarding the distance to the subject S in the storage unit 170.

In the present exemplary application, any one of the light source devices 10-1, 10-2, 10-3, 20, 30, and 30-1 described above may be applied to the distance measurement device 1000 instead of the light source device 10.

### 8.<Exemplary Installation of Distance Measurement Device to Mobile Body>

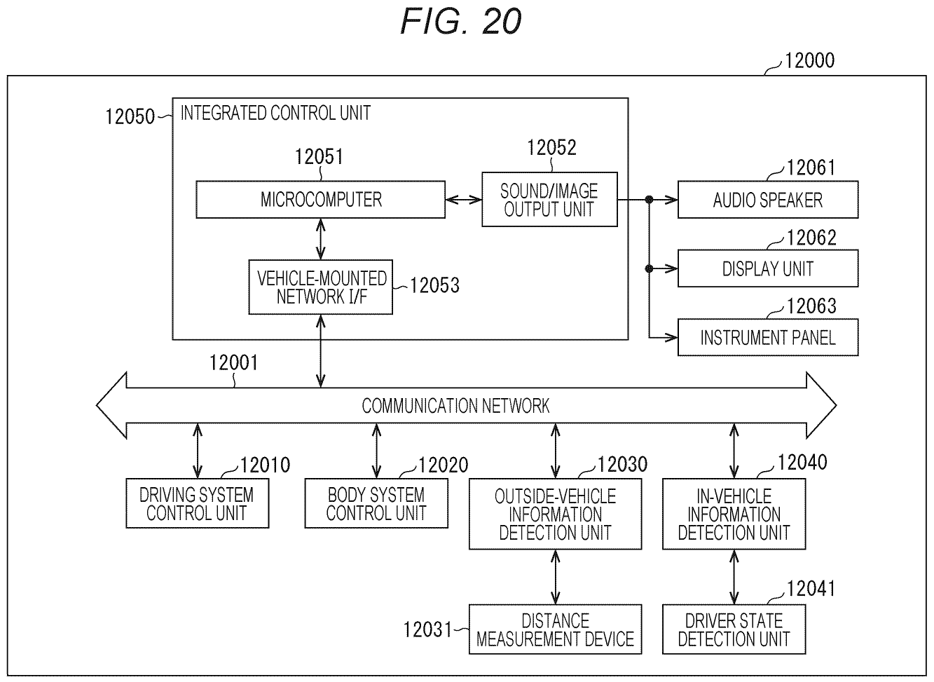

FIG. 20 is a block diagram illustrating an exemplary schematic configuration of a vehicle control system as an exemplary mobile body control system to which the present technology may be applied.

A vehicle control system 12000 includes a plurality of electronic control units mutually connected via a communication network 12001. In the example illustrated in FIG. 20, the vehicle control system 12000 includes a driving system control unit 12010, a body system control unit 12020, an outside-vehicle information detection unit 12030, an in-vehicle information detection unit 12040, and an integrated control unit 12050. In addition, a microcomputer 12051, a sound/image output unit 12052, and a vehicle-mounted network interface (I/F) 12053 are illustrated as a functional configuration of the integrated control unit 12050.

The driving system control unit 12010 controls operations of devices related to a driving system of a vehicle in accordance with various programs. For example, the driving system control unit 12010 functions as a control device of a driving force generating device for generating a driving force of the vehicle, such as an internal combustion engine, a driving motor, or the like, a driving force transmitting mechanism for transmitting the driving force to wheels, a steering mechanism for adjusting a steering angle of the vehicle, a braking device for generating a braking force of the vehicle, and the like.

The body system control unit 12020 controls operations of various devices provided to a vehicle body in accordance with various programs. For example, the body system control unit 12020 functions as a control device of a keyless entry system, a smart key system, a power window device, or various lamps such as a headlamp, a rear lamp, a brake lamp, a turn signal, a fog lamp, or the like. In this case, radio waves transmitted from a mobile device as an alternative to a key or signals of various switches may be input to the body system control unit 12020. The body system control unit 12020 receives those input radio waves or signals, and controls a door lock device, the power window device, the lamps, or the like of the vehicle.

The outside-vehicle information detection unit 12030 detects information regarding the outside of the vehicle including the vehicle control system 12000. For example, a distance measurement device 12031 is coupled to the outside-vehicle information detection unit 12030. The distance measurement device 12031 includes the distance measurement device 1000 described above. The outside-vehicle information detection unit 12030 causes the distance measurement device 12031 to measure a distance to an object (subject S) outside the vehicle, and obtains distance data obtained by the measurement. The outside-vehicle information detection unit 12030 may perform object detection processing of a person, a car, an obstacle, a sign, or the like on the basis of the obtained distance data.

The in-vehicle information detection unit 12040 detects information regarding the inside of the vehicle. For example, a driver state detection unit 12041 that detects a state of a driver is coupled to the in-vehicle information detection unit 12040. The driver state detection unit 12041 includes, for example, a camera that captures an image of the driver and a TOF sensor (e.g., distance measurement device 1000), and the in-vehicle information detection unit 12040 may calculate a degree of fatigue of the driver or a degree of concentration of the driver, or may determine whether the driver is drowsy on the basis of detection information input from the driver state detection unit 12041. Furthermore, a vehicle interior state may be detected on the basis of distance measurement information from the TOF sensor, and in particular, the present technology may suppress emission of a high-output laser at a time of detecting a state of the driver or a passenger, which enhances the safety.

The microcomputer 12051 is capable of calculating a control target value for the driving force generating device, the steering mechanism, or the braking device on the basis of the information regarding the inside or outside of the vehicle obtained by the outside-vehicle information detection unit 12030 or the in-vehicle information detection unit 12040 and outputting a control command to the driving system control unit 12010. For example, the microcomputer 12051 is capable of performing cooperative control intended to implement functions of an advanced driver assistance system (ADAS), which include collision avoidance or shock mitigation for the vehicle, following traveling based on an inter-vehicle distance, vehicle speed maintaining traveling, vehicle collision warning, vehicle lane departure warning, and the like.

Furthermore, the microcomputer 12051 is capable of performing cooperative control intended for automated driving, which makes the vehicle travel in an automated manner without depending on the operation of the driver, or the like, by controlling the driving force generating device, the steering mechanism, the braking device, or the like on the basis of the information regarding the surroundings of the vehicle obtained by the outside-vehicle information detection unit 12030 or the in-vehicle information detection unit 12040.

Furthermore, the microcomputer 12051 is capable of outputting a control command to the body system control unit 12020 on the basis of the information regarding the outside of the vehicle obtained by the outside-vehicle information detection unit 12030. For example, the microcomputer 12051 is capable of performing cooperative control intended for anti-glaring by controlling the headlamp according to a position of a preceding vehicle or an oncoming vehicle detected by the outside-vehicle information detection unit 12030 to perform switching from a high beam to a low beam, or the like.

The sound/image output unit 12052 transmits an output signal of at least one of a sound or an image to an output device capable of visually or auditorily notifying an occupant of the vehicle or the outside of the vehicle of information. In the example of FIG. 20, an audio speaker 12061, a display unit 12062, and an instrument panel 12063 are exemplified as the output device. The display unit 12062 may include, for example, at least one of an on-board display or a head-up display.

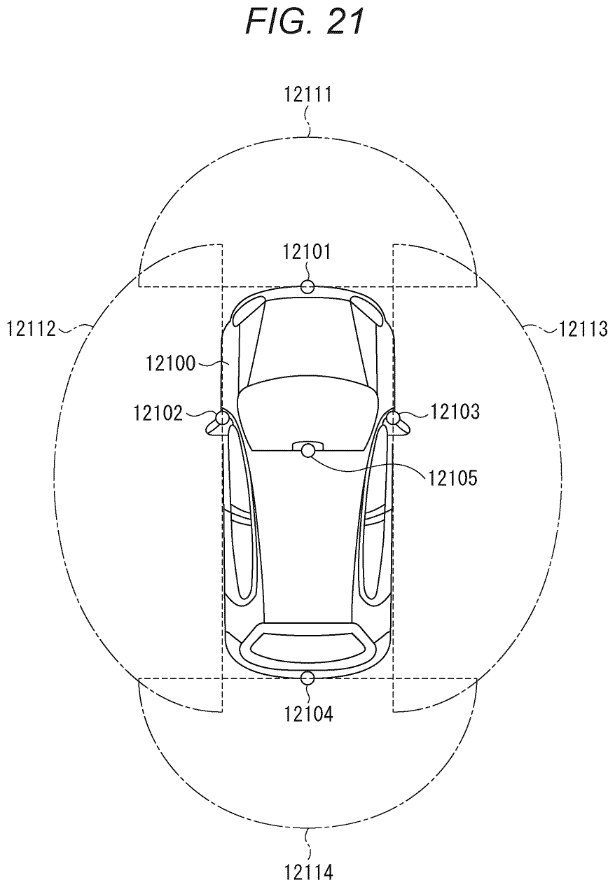

FIG. 21 is a diagram illustrating exemplary installation positions of the distance measurement device 12031.

In FIG. 21, a vehicle 12100 includes, as the distance measurement device 12031, distance measurement devices 12101, 12102, 12103, 12104, and 12105.

For example, the distance measurement devices 12101, 12102, 12103, 12104, and 12105 are provided at positions such as a front nose, sideview mirrors, a rear bumper, a back door, an upper portion of a windshield in a vehicle interior, and the like of the vehicle 12100. The distance measurement device 12101 provided at the front nose and the distance measurement device 12105 provided at the upper portion of the windshield in the vehicle interior mainly obtain data of the front side of the vehicle 12100. The distance measurement devices 12102 and 12103 provided at the sideview mirrors mainly obtain data of the sides of the vehicle 12100. The distance measurement device 12104 provided at the rear bumper or the back door mainly obtains data of the rear side of the vehicle 12100. The data of the front side obtained by the distance measurement devices 12101 and 12105 is mainly used to detect a preceding vehicle, a pedestrian, an obstacle, a traffic light, a traffic sign, or the like.

Note that FIG. 21 illustrates exemplary detection ranges of the distance measurement devices 12101 to 12104. A detection range 12111 indicates a detection range of the distance measurement device 12101 provided at the front nose, detection ranges 12112 and 12113 indicate detection ranges of the distance measurement devices 12102 and 12103 provided at the sideview mirrors, respectively, and a detection range 12114 indicates a detection range of the distance measurement device 12104 provided at the rear bumper or the back door.

For example, the microcomputer 12051 may obtain a distance to each three-dimensional object within the detection ranges 12111 to 12114 and a temporal change in the distance (relative speed with respect to the vehicle 12100) on the basis of the distance data obtained from the distance measurement devices 12101 to 12104, whereby particularly a nearest three-dimensional object present on a traveling path of the vehicle 12100, which travels in substantially the same direction as the vehicle 12100 at a predetermined speed (e.g., equal to or more than 0 km/h), may be extracted as a preceding vehicle. Moreover, the microcomputer 12051 may set an inter-vehicle distance to be maintained from the preceding vehicle in advance, and may perform automated brake control (including following stop control), automated acceleration control (including following start control), or the like. In this manner, it becomes possible to perform the cooperative control intended for automated driving that makes the vehicle travel in an automated manner without depending on the operation of the driver, or the like.

For example, on the basis of the distance data obtained from the distance measurement devices 12101 to 12104, the microcomputer 12051 may classify three-dimensional object data regarding three-dimensional objects into a two-wheeled vehicle, a standard-sized vehicle, a large-sized vehicle, a pedestrian, and another three-dimensional object such as a utility pole, and extract the three-dimensional object data to use it for automated avoidance of obstacles. For example, the microcomputer 12051 makes a discrimination of obstacles around the vehicle 12100 between obstacles that may be visually recognized by the driver of the vehicle 12100 and obstacles that may be difficult for the driver to visually recognize. Then, the microcomputer 12051 determines a collision risk indicating a risk level of collision with each obstacle, and outputs a warning to the driver via the audio speaker 12061 or the display unit 12062 or performs forced deceleration or avoidance steering via the driving system control unit 12010 when a situation occurs in which the collision risk is equal to or higher than a set value and there is a possibility of collision, whereby driving support for avoiding collision may be provided.

An exemplary mobile body control system to which the technology according to the present disclosure may be applied has been described above. The technology according to the present disclosure may be applied to the distance measurement device 12031 among the configurations described above.

Furthermore, the present technology may also adopt the following configurations.

(1) A light source device including:
a light source;
an optical element; and
a holding unit that holds the light source and the optical element, in which
the holding unit includes:
a package that accommodates the light source and has an opening on an optical path of light from the light source, the package being such that the optical element is attached on the package to cover the opening; and
a cover that covers the optical element and the package and allows transmission of light emitted from the light source and has passed through the optical element.

(2) The light source device according to (1), in which the cover suppresses movement of the optical element to a position deviated from the optical path when the optical element is peeled off from the package.

(3) The light source device according to (1) or (2), in which the optical element is disposed between the package and the cover.

(4) The light source device according to any one of (1) to (3), in which the optical element is sandwiched between the package and the cover.

(5) The light source device according to any one of (1) to (4), in which the cover includes a resin cover member.

(6) The light source device according to (5), in which the cover further includes a conductive cover member that covers the resin cover member.

(7) The light source device according to (6), in which the holding unit further includes a substrate to which the package and the conductive cover member are attached, the light source device further including a detection system that detects detachment of the conductive cover member from the substrate.

(8) The light source device according to any one of (5) to (7), in which the resin cover member has conductivity.

(9) The light source device according to (8), in which the holding unit further includes a substrate to which the package and the resin cover member are attached, the light source device further including a detection system that detects detachment of the resin cover member from the substrate.

(10) The light source device according to any one of (1) to (9), in which the cover includes a cover member that has an internal space that holds the optical element on the optical path when the optical element is peeled off from the package.

(11) The light source device according to (10), in which the optical element is larger than the package.

(12) The light source device according to (10) or (11), in which the cover member has conductivity.

(13) The light source device according to (12), in which the holding unit further includes a substrate to which the package and the cover member are attached, the light source device further including a detection system that detects detachment of the cover member from the substrate.

(14) The light source device according to any one of (1) to (13), in which the cover includes a conductive cover member, and the holding unit further includes a substrate to which the package and the conductive cover member are attached, the light source device further including a detection system that detects detachment of the conductive cover member from the substrate.

(15) The light source device according to (14), in which the conductive cover member includes first and second electrode portions to be coupled to the substrate, and the detection system includes a power supply unit that applies a current between the first and second electrode portions, and a voltage detection unit that detects a voltage between the first and second electrode portions.

(16) The light source device according to (14) or (15), further including a control system that controls the light source, in which the control system stops driving of the light source when the detection system detects the detachment.

(17) The light source device according to any one of (1) to (16), in which the optical element includes a diffusion plate.

(18) The light source device according to any one of (1) to (16), in which the optical element includes a diffractive optical element.

(19) The light source device according to any one of (1) to (18), in which the light source includes a laser.

(20) The light source device according to any one of (1) to (19), in which the light source includes an invisible light source.

(21) A distance measuring device including:
the light source device according to any one of (1) to (20); and
a light receiving device that receives light emitted from the light source device and reflected by an object.

(22) A device including the distance measuring device according to (21).

### REFERENCE SIGNS LIST

10, 10-1, 10-2, 10-3, 20, 30, 30-1 Light source device
11 Detection system
12 Control system
50 Holding unit
100 Substrate
110 Light source
120 Package
130, 131 Optical element
140, 141 Resin cover member
140a, 141a, 150b, 151b Internal space
145 Cover
150, 151 Conductive cover member
150b Internal space
300 Power supply unit
400 Voltage detection unit
L Light from light source
E1 First electrode portion
E2 Second electrode portion
125 Light receiving device
1000 Distance measurement device (distance measuring device)

1. A light source device comprising:
a light source;
an optical element; and
a holding unit that holds the light source and the optical element, wherein
the holding unit includes:
a package that accommodates the light source and has an opening on an optical path of light from the light source, the package being such that the optical element is attached on the package to cover the opening; and
a cover that covers the optical element and the package and allows transmission of light emitted from the light source and has passed through the optical element.

2. The light source device according to claim 1, wherein
the cover suppresses movement of the optical element to a position deviated from the optical path when the optical element is peeled off from the package.

3. The light source device according to claim 1, wherein
the optical element is disposed between the package and the cover.

4. The light source device according to claim 1, wherein
the optical element is sandwiched between the package and the cover.

5. The light source device according to claim 1, wherein
the cover includes a resin cover member.

6. The light source device according to claim 5, wherein
the cover further includes a conductive cover member that covers the resin cover member.

7. The light source device according to claim 6, wherein
the holding unit further includes a substrate to which the package and the conductive cover member are attached,
the light source device further comprising a detection system that detects detachment of the conductive cover member from the substrate.

8. The light source device according to claim 5, wherein
the resin cover member has conductivity.

9. The light source device according to claim 8, wherein
the holding unit further includes a substrate to which the package and the resin cover member are attached,
the light source device further comprising a detection system that detects detachment of the resin cover member from the substrate.

10. The light source device according to claim 1, wherein
the cover includes a cover member that has an internal space that holds the optical element on the optical path when the optical element is peeled off from the package.

11. The light source device according to claim 10, wherein
the optical element is larger than the package.

12. The light source device according to claim 10, wherein
the cover member has conductivity.

13. The light source device according to claim 12, wherein
the holding unit further includes a substrate to which the package and the cover member are attached,
the light source device further comprising a detection system that detects detachment of the cover member from the substrate.

14. The light source device according to claim 1, wherein
the cover includes a conductive cover member, and
the holding unit further includes a substrate to which the package and the conductive cover member are attached,
the light source device further comprising a detection system that detects detachment of the conductive cover member from the substrate.

15. The light source device according to claim 14, wherein
the conductive cover member includes first and second electrode portions to be coupled to the substrate, and
the detection system includes:
a power supply unit that applies a current between the first and second electrode portions; and
a voltage detection unit that detects a voltage between the first and second electrode portions.

16. The light source device according to claim 14, further comprising:
a control system that controls the light source, wherein
the control system stops driving of the light source when the detection system detects the detachment.

17. The light source device according to claim 1, wherein
the optical element includes a diffusion plate.

18. The light source device according to claim 1, wherein
the optical element includes a diffractive optical element.

19. A distance measuring device comprising:
the light source device according to claim 1; and
a light receiving device that receives light emitted from the light source device and reflected by an object.

20. A device comprising:
the distance measuring device according to claim 19.
